(19) United States
(12) Patent Application Publication
(10) Pub. No.: US 2007/0093400 A1
(43) Pub. Date: Apr. 26, 2007

(54) DISHWASHING COMPOSITION

(75) Inventors: Jurgen SCHMIDT, Laudenbach (DE); Ralf WIEDEMANN, Ludwigshafen (DE); Karl-Ludwig GIBIS, Ludwigshafen (DE); Enric CARBONELL, Barcelona (ES)

Correspondence Address: Andrew N. Parfomak;Norris McLaughlin & Marcus, PA, 875 Third Avenue, 18th Floor, New York, NY, 10022, US

(73) Assignee: RECKITT BENCKISER N.V., Hoofddorp (NL)

(21) Appl. No.: 11/563,303

(22) Filed: Nov. 27, 2006

Related U.S. Application Data
(62) Division of application No. 10/471,188, filed on Jun. 30, 2004.

(30) Foreign Application Priority Data
Mar. 13, 2001 (GB) 0106089.6

(51) Int. Cl. C11D 7/32

(52) U.S. Cl. 510/175

(57) ABSTRACT

This invention is related to a process for the controlled release into a cleaning environment of an active ingredient of a detergent or detergent additive composition wherein the cleaning environment, to which the detergent or detergent additive composition has been delivered, is exposed to an electric, magnetic or electromagnetic field at an appropriate point in time and for an appropriate time period wherein the release is effective by chemical and/or physical modification, initiated by said field, of at least one specific compound, the modified compound not being directly involved in bleaching; a detergent or detergent additive component with such functionality; a detergent or detergent composition comprising such detergent or detergent additive component; processes for cleaning dishes in an automatic dishwashing machine or for washing fabrics in a laundry washing machine using such detergent compositions; as well as the use of an electric, magnetic or electromagnetic field to control the release of an active detergent ingredient from a source thereof by selectively exposing the environment to which the source has been delivered to such a field.

This invention is related to a process for controlled release into a cleaning environment an active ingredient of a detergent or detergent additive composition, a detergent component used in such a process, a detergent or detergent additive composition comprising such detergent component, processes for cleaning dishes in an automatic dishwashing machine or for washing fabrics in a laundry washing machine using the inventive composition, and the novel use of an electric, magnetic or electromagnetic field for such controlled release.

Detergents used for cleaning dishes in an automatic dishwashing machine or for washing fabrics in a laundry washing machine are known for decades and have become more and more sophisticated over the years. However, there are still numerous problems encountered by consumers in specific respects such as stain removal on dishes and fabrics, colour transfer in washing coloured fabrics, tarnishing of silver in automatic dishwashing, etc.

In many cases, at least part of the problem is caused by an interference between different active ingredients of the detergent or detergent additive composition diminishing the activity of the ingredients during storage or during the washing or cleaning process. As an example, bleaching agents, used both in laundry washing detergent as well as in automatic dishwashing detergent compositions, may not be compatible with a variety of other detergent ingredients. In particular, the negative impact of bleaching agents on the activity of enzymes has been known for a long time. There have been continuous efforts to improve this situation.

One approach is by taking specific means to achieve a controlled release of ingredients to avoid interference amongst the non-compatible ingredients. For example, specific coatings or micro-encapsulation have been proposed releasing the incorporated substances after a certain period of time or upon a specific trigger such as variation in temperature or pH.

It is also known from the prior art to use irradiation by light to controllably activate specific ingredients. For example, the use of photoactivators (also called photobleaches) has been well-known in the area of household laundry processes. Such compounds are activated by exposure to light to catalytically generate bleaching species. They are intended to be absorbed onto the articles having been cleaned by composition comprising them and to be activated upon exposure of the treated articles to light (i.e. upon drying). Such photoactivators and their use in household laundry processes are described in numerous patent documents such as GB 1 372 035, GB 1 372 036, EP 0 038 099, WO 97/05202, WO 97/05203, WO 989/32827, WO 98/23826 and WO 00/52101.

Another approach is described in WO 98/03621. This prior art document describes methods for treating fabrics by irradiating the wash liquor with microwaves to generate heat in the water or solvent contained therein to thereby increase the activity of bleaching agents also contained therein. The microwaves in this case do not affect the release of any ingredient but are used to provide energy to the cleaning environment thereby increasing the efficiency of the process.

The object of the present invention is to provide for a superior process for the controlled release into a cleaning environment of an active ingredient of a detergent or detergent additive composition.

In a first aspect, the present invention is directed to a process for the controlled release into a cleaning environment of an active ingredient of a detergent or detergent additive composition characterized in that the cleaning environment, into which the detergent or detergent additive composition has been delivered, is exposed to an electric, magnetic or electromagnetic field at an appropriate point in time and for an appropriate time period wherein the release is effected by chemical and/or physical modification, initiated by said field, of at least one specific compound, the modified compound not being directly involved in bleaching.

In an alternative first aspect, the present invention is directed to a process for the controlled release into a cleaning environment of an active ingredient from a detergent or detergent additive composition, the detergent or detergent additive composition additionally comprising at least one release modifying material, the process comprising exposing the cleaning environment, into which the detergent or detergent additive composition has been delivered, to an electric, magnetic or electromagnetic field sufficient to effect chemical and/or physical modification of the release modifying material for release of the active ingredient.

By exposure to an electric, magnetic or electromagnetic field at an appropriate point in time and for an appropriate time period it is meant the controlled exposure at a pre-established point in time during the cleaning cycle and for a selected length of time. The starting point and the length of the exposure can be either fixed in an absolute way (i.e. by a time controlled device) or with the help of a control system which activates electric, magnetic or electromagnetic field as a response to some measurable parameter in the washing liquor (i.e. temperature, pH, concentration of a certain chemical species, . . . ).

In one preferred embodiment of this process, the controlled release is achieved by using, as a source of the active ingredient, a composition comprised of the active ingredient or a precursor thereof distributed in a matrix of release modifying material or coated by a release modifying material which material has a solubility, dispersibility or permeability which, in the conditions present in the cleaning environment, is increased upon exposure of such material to the electric, magnetic or electromagnetic field.

In another preferred embodiment of the invention, the controlled release is achieved by using, as a source of the active ingredient, a precursor of the active ingredient which precursor generates the active ingredient under conditions arising from exposure of the cleaning environment to the electric, magnetic or electromagnetic field, the generation of the active ingredient from the precursor being, however, at least not predominantly achieved by temperature variation.

Preferably, the generation of the active ingredient from the precursor is achieved by chemical modification of the precursor through a photo-inducible reaction.

Alternatively, the generation of the active ingredient from the precursor is achieved by modification of the precursor by a photo-generated chemical.

In a preferred embodiment of the invention, the cleaning environment is exposed to electromagnetic radiation, most preferably ultraviolet or visible light.

In a second aspect, the invention is directed to a detergent or detergent additive component that releases an active ingredient upon exposure of the component or of a cleaning environment, into which the component has been delivered, to an electric, magnetic or electromagnetic field wherein the release is effected by chemical and/or physical modification, initiated by said field, of at least one specific compound, the modified compound not being directly involved in bleaching.

In a second aspect, the invention is directed to a detergent or detergent additive composition comprising at least one active ingredient and a release modifying material, the chemical and/or physical release properties of the material being increased by exposure to an electric, magnetic or electromagnetic field.

In a first alternative, such detergent or detergent additive component comprises an active ingredient dispersed in a matrix of material or coated by a release modifying material which material has a solubility, dispersibility or permeability which, in the conditions present in the cleaning environment, is increased upon exposure of such material to the electric, magnetic or electromagnetic field.

In another embodiment of the invention, the detergent or detergent additive component comprises a precursor of the active ingredient which precursor generates the active ingredient upon conditions arising from exposure of the cleaning environment to the electric, magnetic or electromagnetic field, the generation of the active ingredient from the precursor being, however, at least not predominantly achieved by temperature variation.

Preferably, the precursor is selected from the group of compounds which are chemically modifiable through a photo-inducible reaction or, alternatively, from the group of compounds which are modifiable by a photo-generated chemical.

In a third aspect, the invention is directed to a detergent or detergent additive composition comprising a detergent or detergent additive component according to the invention.

In a fourth aspect, the invention is directed to a process for cleaning dishes in an automatic dishwashing machine wherein a detergent composition is delivered into the wash liquor and that the detergent composition or the wash liquor is exposed to an electric, magnetic or electromagnetic field.

In a fifth aspect, the invention is directed to a process for washing fabrics in an automatic dishwashing machine wherein a detergent composition is delivered into the wash liquor and that the detergent composition or the wash liquor is exposed to an electric, magnetic or electromagnetic field.

In a sixth aspect, the present invention is directed to the use of an electric, magnetic or electromagnetic field to control the release of an active detergent ingredient from a source thereof by selectively exposing the environment to which the source has been delivered to such a field.

For the purpose of this application, the term “active ingredient” is to be used in the meaning of any ingredient exerting or initiating any activity relevant for the function of a detergent or detergent additive composition. The term “photo-inducible” is to be used in the meaning of any ingredient or reaction, which needs exposure to electromagnetic radiation to develop reactivity.

It is the novel approach of the present invention to control the release of an active ingredient into a cleaning environment by exposing it to an electric, magnetic or electromagnetic field, thereby initiating the chemical and/or physical modification of specific compounds thereby effecting the release of the active ingredients.

Different mechanisms for the controlled release have been considered under this basic idea of the invention, which lead to different embodiments according to the present invention.

The first mechanism is based on the distribution of the active ingredient or a precursor thereof in a matrix of material or on the protection thereof by coating or encapsulation with a material wherein the solubility, permeability or dispersibility of the material is increased upon exposure to an electric, magnetic or electromagnetic field.

This material, forming or being comprised in the matrix holding the active ingredient or precursor thereof or forming or being comprised in the coating or encapsulation material protecting the active ingredient or a precursor thereof, can either be a material whose solubility, permeability or dispersibility is directly increased by a photo-induced chemical reaction or a material whose solubility, permeability or dispensability is increased as a result of an interaction of the material with a chemical compound generated by a photo-induced chemical reaction within the matrix, coating or encapsulation material or within the detergent or detergent active composition itself.

Still another possibility is that the material is not chemically affected neither directly by the electric, magnetic or electromagnetic field or indirectly by the photo-generated chemical compound, but the properties of the aggregates of the material (liposomes, vesicles, etc.) are physically modified to increase the solubility, permeability or dispersibility of the material.

When the matrix, coating or encapsulation material itself is affected by the electric, magnetic or electromagnetic field, e.g. by a photo-induced chemical reaction, the material may either be itself a photo-reactive compound such as a photo-reactive polymer, or a mixture of one or more non-reactive compounds and one or more photo-reactive compounds.

Photoreactive polymers are known from the field of photomechanical reproduction since the 1940s. One of the basic patents in this field, GB 737,379, is directed to a photosensitive reproduction material comprising a light-sensitive coating containing a light-sensitive water-insoluble alkali-insoluble quinone diazide which on exposure to light becomes soluble in alkali. Materials of this type are considered within the present invention to be used in admixture with the matrix, coating or encapsulation material because of their increase in solubility thereby weakening or disrupting the matrix, coating or encapsulation to initiate the release of the material contained therein.

A huge number of other patent documents is related to similar materials, known as photoresists, such as EP 0 176 871, describing an UV-light sensitive photoresist layer made of novolac and naphthoquinone diazide.

In the second alternative, the matrix, coating or encapsulation material may be inert towards the direct influence of the electric, magnetic or electromagnetic field such as ultraviolet or visible light, but is susceptible to a reaction with a chemical generated by the effects of said field.

One possible execution of this second alternative is the use of Photo-chemically degradable micro-capsules having a wall made of polymer material comprising silylether or silyl ureido bonds which are cleavable by acids as well as compounds generating acid upon exposure to light such as trihalogen methyl substituted s-triazine derivatives, oxadiazole derivatives, iodonium salts, sulfonium salts, disulfone derivatives, imido sulfonate derivatives and diazonium salts.

In another alternative, use is made of light sensitive liposomes, which are known from the pharmaceutical fields for preparing controlled release medical preparations.

U.S. Pat. No. 4,882,165, for example, describes light sensitive liposomes, which release their contents in response to irradiation with an appropriate wavelength of light. The light sensitive liposomes include lipids having at least one retinoyl group and being a structural component of the lipid membrane. Trans-cis transitions initiated by exposure to light destabilize the liposome thus enabling controlled release of the contents thereof.

Finally, it is also considered as another possible embodiment within the present invention, that the matrix, coating or encapsulation material is neither directly nor indirectly chemically affected at all, but where the properties of the aggregates formed by this material are affected

A second basic mechanism for the controlled release according to the present invention is the modification of an inert precursor of the active ingredient either directly through photo-induced reaction or by the reaction with a chemical compound generated by the effects of the electric, magnetic or electromagnetic field. Examples of precursors directly modifiable upon exposure to electromagnetic radiation are precursors of bleaching agents activated upon exposure to light, in particular UV light, which are, however, well known from the prior art, as mentioned hereinabove. Therefore, such compounds are explicitly excluded from this invention as reflected in the claims.

There are, however, other examples for such precursors falling within the scope of the invention.

One such example is the use of enzyme precursors, such as o-nitrobenzyl derivatives of enzymes obtained by condensing at least one amino function of the enzymes with benzyloxycarbonylchloride. Upon exposure of the nitrobenzyl derivatives to light having a wavelength between 350 and 380 nm the enzymes are released.

Another example is the use of precursors of chelating agents such as 1-acyl-7-nitroindoline compounds where the acyl group is derived from carboxylic acid chelating agents which upon irradiation with light having a wavelength between 340 and 370 nm release the chelating agents.

Still another example is the use of a precursor of a polycarboxylic polymer such as a polyacrylate precursor. Such precursors can be obtained for instance by partially esterifying polyacrylates with aromatic o-nitrocarbinols compounds such as o-nitro benzyl alcohol or by polymerising or copolymerising esters of aromatic o-nitrocarbinols with olefinically unsaturated monomeric carboxylic acids. The ester bond of such precursors is cleaved upon irradiation and generates the free polycarboxylic polymer on one side and an aromatic o-nitro aldehide or o-nitroketone on the other.

The features of the invention disclosed in the description and claims can be essential to the implementation of the different embodiments of the invention, either singly or in random combination.

1-7. (canceled)

8. A detergent or detergent additive component that releases an active ingredient upon exposure of the component or of a cleaning environment, into which the component has been delivered, to an electric, magnetic or electromagnetic field wherein the release of the active ingredient is effected by chemical and/or physical modification, initiated by said field, of at least one specific compound, which, after being modified by the interaction with the field does not generate a compound being directly involved in bleaching.

9. The detergent or detergent additive component according to claim 8 characterized in that it comprises an active ingredient dispersed in a matrix of material or coated by a material which material has a solubility, dispersibility or permeability which, in the conditions present in the cleaning environment, is increased upon exposure of such material to the electric, magnetic or electromagnetic field.

10. The detergent or detergent additive component according to claim 8 characterized in that it comprises a precursor of the active ingredient which precursor generates the active ingredient upon conditions arising from exposure of the cleaning environment to the electric, magnetic or electromagnetic field, the generation of the active ingredient from the precursor being, however, at least not predominantly achieved by temperature variation.

11. The detergent or detergent additive component according to claim 10 characterized in that the precursor is selected from the group of compounds which are chemically modifiable through a photo-induced reaction.

12. The detergent or detergent additive component according to claim 10 characterized in that the precursor is selected from the group of compounds, which are modifiable, by a photo-generated chemical.

13. A detergent or detergent additive composition comprising a detergent or detergent additive component according to claim 8.

14. A detergent or detergent additive composition comprising a detergent or detergent additive component according to claim 9.

15. A detergent or detergent additive composition comprising a detergent or detergent additive component according to claim 10.

16. A detergent or detergent additive composition comprising a detergent or detergent additive component according to claim 11.

17. A detergent or detergent additive composition comprising a detergent or detergent additive component according to claim 12.

18.-25. (canceled)

26. A detergent or detergent additive component according to claim 8, wherein the release of the active ingredient is effected by chemical and/or physical modification of a light sensitive lipid having at least one retinoyl group, initiated by said field, of at least one specific compound, which, after being modified by the interaction with the field does not generate a compound being directly involved in bleaching.

27. A detergent or detergent additive component according to claim 10, wherein the precursor of the active ingredient is an enzyme precursor.

28. A detergent or detergent additive component according to claim 27 wherein the enzyme precursor are o-nitrobenzyl derivatives of enzymes obtained by condensing at least one amino function of an enzyme with benzyloxycarbonylchloride.

29. A detergent or detergent additive component according to claim 10, wherein the precursor of the active ingredient is a precursor of a chelating agent.

30. A detergent or detergent additive component according to claim 29, wherein the precursor of the chelating agent is a 1-acyl-7-nitroindoline compound where the acyl group is derived from carboxylic acid chelating agents.

31. A detergent or detergent additive component according to claim 10, wherein the precursor of the active ingredient is a precursor of a polycarboxylic acid polymer.

32. A detergent or detergent additive component according to claim 31, wherein the precursor of a polycarboxylic acid polymer is a polyacrylate precursor.
